(19) United States
(12) Patent Application Publication
(10) Pub. No.: US 2025/0236417 A1
(43) Pub. Date: Jul. 24, 2025

(54) SYSTEM AND METHOD FOR A SUPERCONDUCTIVE, ELECTROMAGNETIC LAUNCHER

(71) Applicant: Thomas F. Yost, Chesapeake Beach, MD (US)

(72) Inventor: Thomas F. Yost, Chesapeake Beach, MD (US)

(21) Appl. No.: 18/663,335

(22) Filed: May 14, 2024

Related U.S. Application Data
(60) Provisional application No. 63/466,327, filed on May 14, 2023.

(51) Int. Cl. B64G 1/00

(52) U.S. Cl. CPC B64G 1/005

(57) ABSTRACT

A superconductive, electromagnetic launch system is implemented on a stratospheric airship. The launcher includes a plurality of twisted cylinders, wherein each of the plurality of cylinders has an infinity-type shape or other shape including one or two lobes. The lobes of the plurality of cylinders are aligned, and adjacent cylinders are connected by a bridge to form one continuous guideway. Superconducting coils are positioned external to a bore in the guideway and generate a magnetic field or flux within the bore that levitates and propels the vessel. A cooling system cools the superconducting coils to a transition temperature at which one or more superconducting materials in the plurality of coils transition to a superconducting state. The vessel is accelerated in the guideway and launched from a stratospheric altitude of the airship at a velocity necessary to reach space.

### CROSS REFERENCE TO RELATED APPLICATIONS

The present application claims priority under 35 U.S.C. § 119 to U.S. Provisional Application No. 63/466,327 entitled, “SPACE CARGO DIRIGIBLE AND LAUNCHER,” filed May 14, 2023, and hereby expressly incorporated by reference herein.

U.S. patent application Ser. No. ______, entitled, “SYSTEM AND METHOD FOR DIMPLED SPHERICAL STORAGE UNITS,” by inventor Thomas Yost, and filed on the same day as this application, the entirety of which is incorporated by reference herein.

U.S. patent application Ser. No. ______, entitled, “SYSTEM AND METHOD FOR A SPACECRAFT DOCKING STATION,” by inventor Thomas Yost, and filed on the same day as this application, the entirety of which is incorporated by reference herein.

U.S. patent application Ser. No. ______, entitled, “SYSTEM AND METHOD FOR SMART SPHERICAL CLUSTER VESSELS,” by inventor Thomas Yost, and filed on the same day as this application, the entirety of which is incorporated by reference herein.

U.S. patent application Ser. No. ______, entitled, “SYSTEM AND METHOD FOR A STRATOSHPERIC AIRCRAFT,” by inventor Thomas Yost, and filed on the same day as this application, the entirety of which is incorporated by reference herein.

### FIELD

This application relates to systems and methods for a superconductive, electromagnetic launcher and more specifically, a superconductive, electromagnetic launcher for launching cargo containers into space such as from a stratospheric transport.

### BACKGROUND

The use of rockets is the prominent means to launch cargo, such as satellites and supplies, as well as humans into space. However, rockets have significant environmental implications. Rockets emit a large amount of greenhouse gases, such as carbon dioxide and water vapor, directly into the upper atmosphere. Additionally, the production and handling of rocket fuels, particularly highly toxic substances like hydrazine and nitrogen tetroxide, pose serious environmental risks. Their potential leakage or accidental release during launch preparations or failures can lead to soil and water contamination, as well as harm to ecosystems. Moreover, the depletion of the ozone layer caused by rocket emissions and the subsequent increase in ultraviolet radiation reaching the Earth's surface is an alarming consequence. The rocket fuel and emissions thus not only pose a threat to human health and wildlife but also contributes to global climate change.

Ethically, the use of rockets for space cargo and satellite launch also raises concerns due to the growing problem of space debris. The presence of space debris in Earth's orbit, as a result of defunct satellites and spent rocket stages, poses risks to operational satellites and spacecraft, as well as astronaut safety. The accumulation of space debris not only obstructs future space missions but also endangers the sustainability of space activities.

One alternative technology to rockets includes electromagnetic (EM) launchers that convert electrical energy into mechanical propulsion to launch objects into space from the ground. However, these known EM launchers require lengthy barrels that must withstand extremely high forces to launch objects into orbit from the ground, leading to reliability and integrity problems. In addition, the EM launchers require large capacitor banks to provide the necessary power. These factors hinder the use of known EM launchers in confined areas with limited power storage.

In view of the above disadvantages and others described in this specification, improved technologies for reusable space launch systems are needed that reduce costs, power, and environmental concerns.

### SUMMARY

In one aspect, a launch system for launching a vessel includes a plurality of cylinders that form a continuous guideway. Each of the plurality of cylinders include at least one lobe and one overlapping portion, wherein the at least one lobe of each of the plurality of cylinders are substantially aligned. The launch system further includes a plurality of coils that comprise one or more superconducting materials, wherein the plurality of coils are positioned externally to a bore in the continuous guideway. The plurality of coils are configured to generate a magnetic field within the bore that levitates and propels the vessel within the bore. A cooling system cools the plurality of coils to or below a transition temperature at which the one or more superconducting materials in the plurality of coils transition to a superconducting state.

In another aspect, a launch system for launching a vessel is implemented on an aircraft. A plurality of coils include one or more superconducting materials and are positioned externally to a bore in a guideway. The plurality of coils generate a magnetic field within the bore that levitates and accelerates the vessel within the bore. A cooling system cools the plurality of coils to at least a transition temperature at which the one or more superconducting materials in the plurality of coils transition to a superconducting state. A launch system controller initiates a launch of the vessel from the guideway in response to the vessel reaching at least a predetermined speed within the guideway, e.g., wherein the predetermined speed is sufficient for the vessel to reach space from an altitude of the aircraft.

In another aspect, a method includes launching a vessel from a launch system that is positioned on an aircraft. The method includes determining that the aircraft is at a stratospheric altitude and generating a magnetic field within a guideway of the launch system, wherein the magnetic field repels the vessel and causes the vessel to levitate within a bore of the guideway. The method further includes accelerating the vessel within the bore of the guideway and determining the vessel has reached a predetermined velocity, e.g., wherein the predetermined velocity is sufficient for the vessel to reach space from the stratospheric altitude of the aircraft. The method then includes launching the vessel from the guideway.

In one or more of the above aspects, the one or more of the plurality of coils include propulsion coils. The propulsion coils are configured to generate an increase in the magnetic field at a predetermined position in the bore to accelerate the vessel.

In one or more of the above aspects, a power source is configured to provide power to the propulsion coils. An increase in the power from the power source to the propulsion coils increases the magnetic field at the predetermined position in the bore to increase a velocity of the vessel.

In one or more of the above aspects, each pair of adjacent cylinders of the plurality of cylinders are coupled by at least one cylinder pathway bridge. The cylinder pathway bridge between each pair of adjacent cylinders forms a portion of the continuous guideway.

In one or more of the above aspects, a pressure controller is configured to decrease a pressure within the bore.

In one or more of the above aspects, the plurality of cylinders include at least one exit hatch for launching the vessel from the continuous guideway and one or more lasers for generating one or more laser beams into a flight trajectory of the vessel.

In one or more of the above aspects, the plurality of cylinders include at least one entry portal into the bore of the continuous guideway and an autoloader for loading the vessel into the continuous guideway.

In one or more of the above aspects, the autoloader includes a pressure chamber configured to receive the vessel and adjust a pressure within the pressure chamber to approximately a pressure in the bore of the continuous guideway.

In one or more of the above aspects, the autoloader includes a chamber configured to coat a surface of the vessel with cryogenic liquid. The surface, or outer layer near the surface, or within the body of the vessel comprises one or more superconducting materials such that a superconductivity of the vessel repels the magnetic field within the bore.

In one or more of the above aspects, the autoloader includes a spin generator that initiates the vessel to spin and propel prior to entering the at least one entry portal, wherein the spin generator includes a flipper accelerator.

In one or more of the above aspects, the launch system is positioned on an aircraft.

In one or more of the above aspects, the aircraft is configured to operate in a stratosphere of Earth.

In one or more of the above aspects, a portion of the plurality of cylinders is external to the aircraft, e.g., wherein the external portion includes at least one-third to one-half of a height of the plurality of cylinders.

In one or more of the above aspects, each of the plurality of cylinders includes the at least one lobe and a second lobe. At least one overlapping portion connects the at least one lobe and the second lobe.

In one or more of the above aspects, a plurality of twisted cylinders form the guideway. Each of the plurality of cylinders have an infinity-type shape including a first lobe, a second lobe and an overlapping portion. The first lobe of each of the plurality of cylinders are substantially aligned.

In one or more of the above aspects, generating the magnetic field within the guideway of the launch system includes cooling the plurality of coils to or below a transition temperature at which one or more superconducting materials in the plurality of coils transition to a superconducting state. The plurality of coils are positioned external to the bore in the guideway and generate a magnetic field within the bore that causes the vessel to levitate and be propelled within the bore.

In one or more of the above aspects, accelerating the levitating vessel within the bore of the guideway includes increasing a current to the plurality of coils at a predetermined position in the bore to increase the magnetic field and increase a velocity of the vessel. The magnetic field interacts and repels the vessel. The vessel includes a superconducting material with at least a partial coverage of cryogenic liquid nitrogen or a ferromagnetic material.

In one or more of the above aspects, launching the vessel from the guideway includes adjusting one or more actuators at an exit hatch to a predetermined launch angle and launching the vessel from the exit hatch at the predetermined launch angle.

### BRIEF DESCRIPTION OF THE DRAWINGS

FIG. 1 illustrates an elevational view of an exemplary embodiment of a launch system and stratospheric aircraft.

FIG. 2A illustrates an elevational view of an exemplary embodiment of a guideway of the launch system.

FIG. 2B illustrates an elevational view of an exemplary embodiment of a cross-sectional shape of a cylinder in the guideway of the launch system.

FIG. 2C illustrates an elevational view of an exemplary embodiment of another cross-sectional shape of a cylinder in the guideway of the launch system.

FIG. 2D illustrates an elevational view of an exemplary embodiment of a shape of a cylinder in the guideway of the launch system.

FIG. 2E illustrates an elevational view of an exemplary embodiment of another shape of a cylinder in the guideway of the launch system.

FIG. 2F illustrates an elevational view of an exemplary embodiment of another shape of the plurality of cylinders in the guideway of the launch system.

FIG. 2G illustrates an elevational view of an exemplary embodiment of the plurality of cylinders in the guideway of the launch system.

FIG. 3A illustrates a block diagram of an exemplary embodiment of a cross-section of the guideway.

FIG. 3B illustrates a block diagram of an exemplary embodiment of another cross-section of the guideway.

FIG. 4 illustrates a block diagram of an exemplary embodiment of the launch system.

FIG. 5 illustrates a block diagram of an exemplary embodiment of the autoloader.

FIG. 6 illustrates an elevational view of an exemplary embodiment of the vessel storage and autoloader.

FIG. 7 illustrates an elevational view of another exemplary embodiment of the vessel storage and autoloader.

FIG. 8 illustrates a flow diagram of an embodiment of a method for loading a vessel into the guideway.

FIG. 9 illustrates an elevational view of an embodiment of a thermal laser system.

FIG. 10 illustrates a flow diagram of an embodiment of a method for launching a vessel from the guideway.

### DETAILED DESCRIPTION

The word “exemplary” or “embodiment” is used herein to mean “serving as an example, instance, or illustration.” Any implementation or aspect described herein as “exemplary” or as an “embodiment” is not necessarily to be construed as preferred or advantageous over other aspects of the disclosure. Likewise, the term “aspects” does not require that all aspects of the disclosure include the discussed feature, advantage, or mode of operation.

Embodiments will now be described in detail with reference to the accompanying drawings. In the following description, numerous specific details are set forth in order to provide a thorough understanding of the aspects described herein. It will be apparent, however, to one skilled in the art, that these and other aspects may be practiced without some or all of these specific details. In addition, well known steps in a process may be omitted from flow diagrams and descriptions presented herein in order not to obscure the aspects of the disclosure. Similarly, well known components in a device or well-known systems may be omitted from figures and descriptions thereof presented herein in order not to obscure the aspects of the disclosure.

### Overview

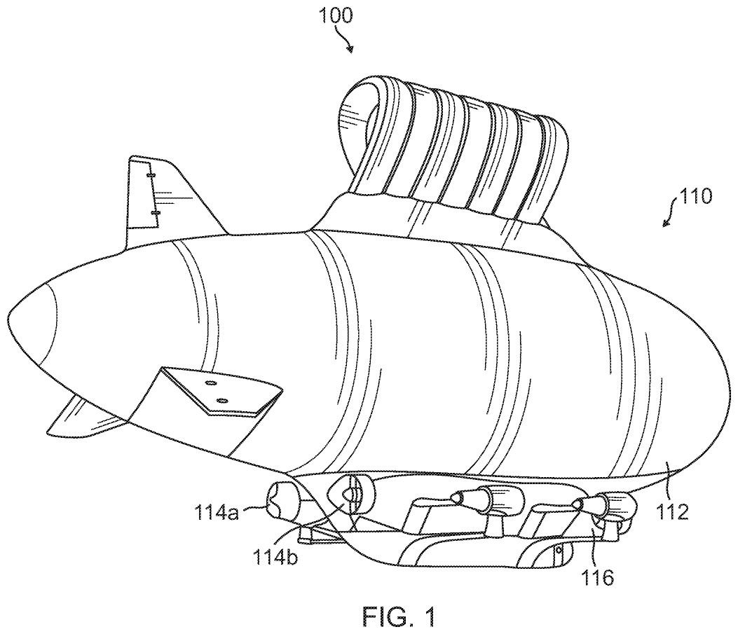

FIG. 1 illustrates an elevational view of an exemplary embodiment of a launch system 100 and stratospheric aircraft 110. In one embodiment, the aircraft 110 may be a manned or unmanned airship, dirigible, blimp or other vehicle transported by a lifting gas that is lighter than air. The aircraft 110 is configured to obtain stratospheric altitudes, e.g., altitudes in a range between 12 kilometers (km) and 50 km. The aircraft 110 includes a main structure or hull 112 that holds the lifting gas (such as helium and/or hydrogen) and one or more steering propellers 114a-b. The propellers 114a-b may be adjustable to provide an upward thrust to gain altitude and for maneuverability. The aircraft 110 may further include an undercarriage 116 for storage of cargo if unmanned and/or for pilots if a manned aircraft 110. In another embodiment, the aircraft 110 may include an airplane, helicopter, hovercraft, or other type of airship.

The launch system 100 is integrated with and/or implemented on and/or positioned on the aircraft 110. The launch system 100 includes an electromagnetic, superconductive guideway formed by plurality of twisted cylinders. Superconducting magnets are spaced throughout a guideway formed in the cylinders and generate powerful magnetic fields to levitate and/or propel a ferromagnetic vessel or one whose outer shell is made of superconducting material dipped with cryogenic liquid through a bore of the guideway. The magnetic fields accelerate the vessel through the guideway in a controlled process until the vessel reaches a predetermined velocity, such as Mach 2.5 to Mach 5.0. An exit hatch is then opened in the guideway, and the vessel is launched from the aircraft 110 at a preconfigured flight trajectory.

In an embodiment, the predetermined velocity is a velocity sufficient for the vessel to reach space. The escape velocity may be determined using one or more factors such as an altitude of the aircraft 110, air pressure, temperature, wind speed, trajectory of the vessel, or use of thrusters on the vessel. This escape velocity for the vessel will be far less than for rockets or other projectiles fired from the ground because the aircraft 110 launches the vessel from the stratosphere. For example, when the aircraft 110 is at an altitude of 40 km, only an additional 40 km to 60 km more are needed for the vessel to reach space. In one embodiment, the vessel may be equipped with a propulsion system, such as thrusters, to obtain additional velocity and/or for maneuvering in the stratosphere or space.

The aircraft 110 and launch system 100 may be reused for multiple missions/flights and multiple vessels may be launched during the same mission/flight of the aircraft 110. This reuse reduces the space debris left by traditional rockets from single use rocket stages. The aircraft 110 and launch system 100 also do not release dangerous emissions into the atmosphere. The system thus decreases the environmental impact in comparison to traditional rocket launchers that emit a large amount of greenhouse gases, such as carbon dioxide and water vapor, directly into the upper atmosphere. In addition, the design of the launch system 100 on the stratospheric aircraft 110 requires less power to launch the vessels into orbit in comparison to traditional gun rails or other known launchers positioned on the ground. The configuration of the guideway of the launcher also requires less space, and so the guideway is able to fit within the confined areas of the aircraft 110.

### Exemplary Embodiments of the Launch System

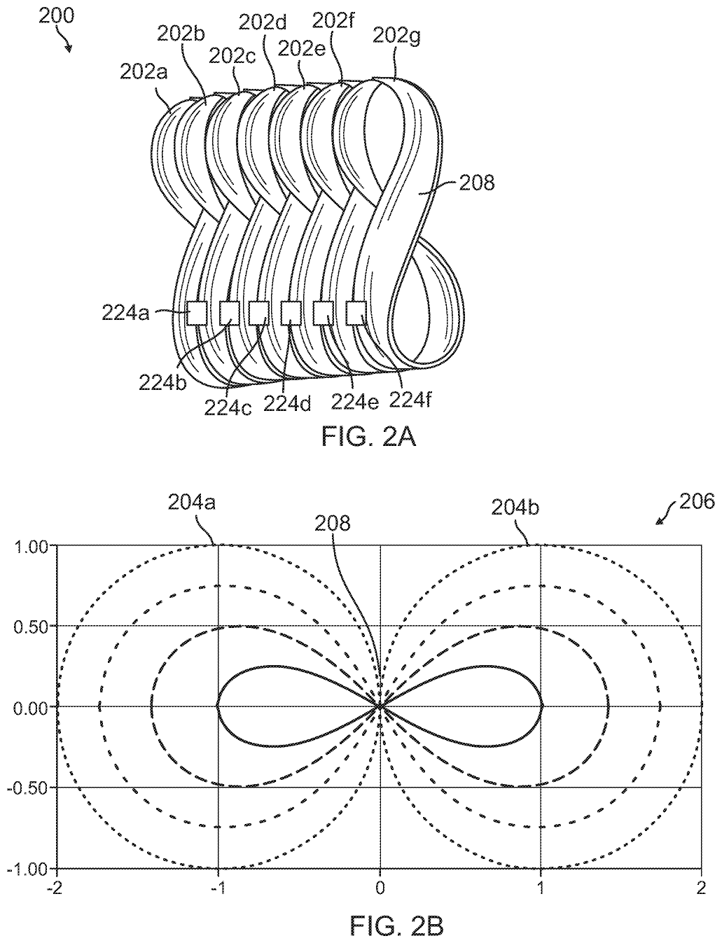

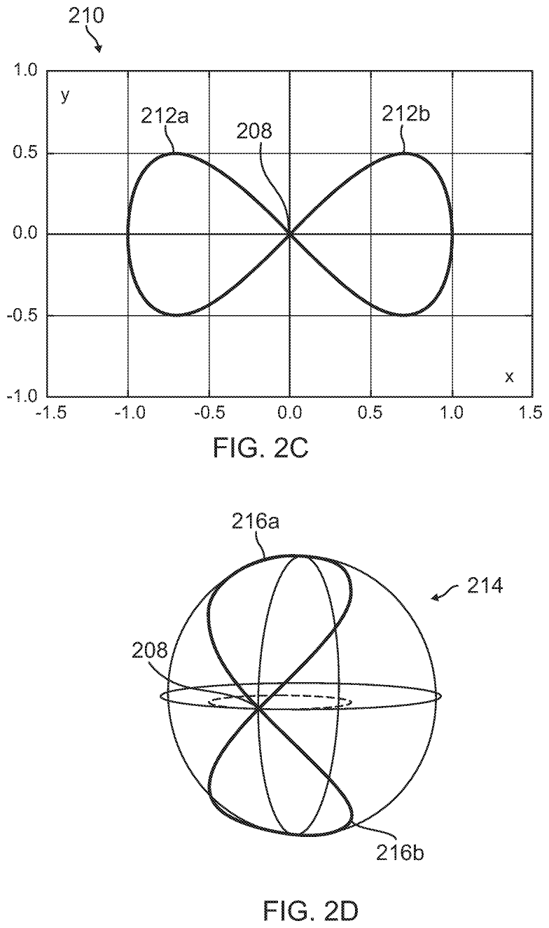

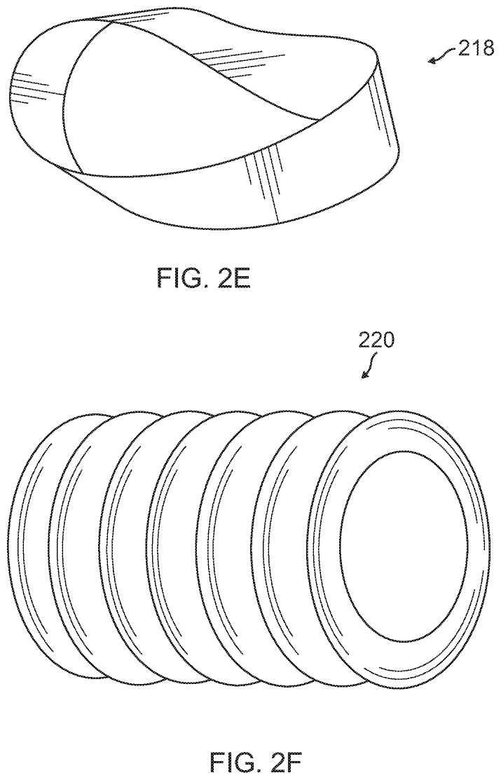

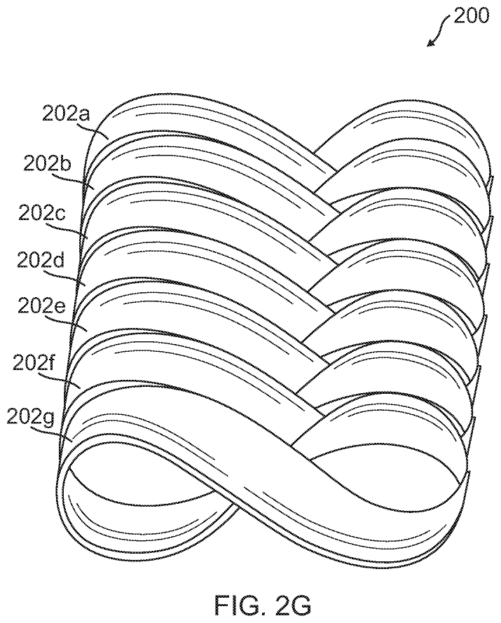

FIG. 2A illustrates an elevational view of an exemplary embodiment of a guideway 200 of the launch system 100. The guideway 200 includes a plurality of cylinders 202a-g. Though seven cylinders 202a-g are shown, more or less cylinders 202a-g may be implemented in the launch system 100. The plurality of cylinders 202a-g are coupled by a bridge, such as a cylinder pathway. For example, at least one cylinder pathway bridge 224a-f is positioned between each pair of adjacent cylinders 202a-g and connect the pathways for the vessel in each pair of the adjacent cylinders 202a-g. As such, adjacent cylinders 202a-g are coupled by at least one bridge 224a-f, such that a vessel within the guideway 200 may move from one cylinder 202a-g to another, adjacent cylinder 202a-g over at least one bridge 224a-f. The cylinders 202a-g and the bridges 224a-f thus form a continuous guideway 200 for the vessel.

In one embodiment, each of the cylinders 202a-g have an infinity type shape with an overlapping portion 208, wherein the cylinder 202a-g overlaps itself. The cylinders 202a-g include a cross-sectional plane that forms any one of several lemniscate-type shapes, also known as figure-eight shapes. For example, the cylinders 202a-g shown in FIG. 2A have an infinity-type shape with a cross-section that includes a Booth-type lemniscate 206, as shown in FIG. 2B. In a Booth-type lemniscate 206, two lobes 204a-b of the cylinders 202a-g may have an oval, teardrop, or circular shape. In another embodiment shown in FIG. 2C, the cylinders 202a-g have a cross-section that includes a Gerono-type lemniscate 210. The lobes 212a-b in this example have a pear-type or teardrop-type shape. In yet another embodiment, the cylinders 202a-g have a shape resembling a three dimensional (3-D) Viviani's curve 214, as shown in FIG. 2D. The lobes 216a-b in the 3-D Viviani's curve 214 are circular or oval but are also bent or curved with respect to the twisted center or overlapping portion 208.

In the examples shown in FIGS. 2A-2D, each one of the plurality of cylinders 202a-g includes a cylindrical casing (e.g., that surrounds the guideway) that forms at least two lobes and at least one overlapping portion 208. In the overlapping portion 208, the cylindrical casing overlaps itself and connects the first lobe to the second lobe to form an infinity-type shape. Though the lobes of the cylinders 202a-g are shown as equally sized in these examples, one lobe may be longer than another lobe. In addition, one lobe of the cylinder 202a-g may have a first shape, such as a circle, oval, tear-drop or pear shape, and the other lobe may have a second, different shape.

In other implementations, the cylinders 202a-g may have a Mobius strip type shape 218, e.g., a half-twist that is inserted between two attached ends of the cylinder 202a-g, as shown in FIG. 2E. The cylinders 202a-g may have a simpler shape, such as a torus 220, as shown in FIG. 2F. In these implementations, the cylinders 202a-g include a single lobe or loop.

In these embodiments of FIGS. 2A-2F, the cylinders 202a-g are positioned adjacently (next to or touching) such that a first lobe of a cylinder 202a-g is substantially aligned with the first lobes of each of its adjacent cylinders 202a-g, and the second lobe (if present) of a cylinder 202a-g is substantially aligned with the second lobe of each of its adjacent cylinders 202a-g. By substantially aligned, the first lobes of the plurality of cylinders each form an external, continuous space that extends through the first lobe of each of the plurality of cylinders 202a-g, and/or the second lobes (if present) of the plurality of cylinders each form another external, continuous space that extends through the second lobe of each of the plurality of cylinders 202a-g.

And though the cylinders 202a-g are shown vertically in FIGS. 1 and 2A, e.g., the first lobe of a cylinder 202a-g is positioned vertically with respect to its second lobe, the cylinders 202a-g may be positioned horizontally, as shown in FIG. 2G. These exemplary configurations of the plurality of cylinders 202a-g increase the length of the guideway 200 within a limited area, e.g., such as within the aircraft 110. To further conserve area within the structure of the aircraft, the guideway 200 may be implemented with or positioned on the aircraft 110 such that it is partially within the aircraft 110 and partially external to the aircraft 110. For example, as shown in FIG. 1, a lower portion or a first lobe of each of the cylinders 202a-g is positioned within the main structure of the aircraft 110 and an upper portion or second lobe of the cylinders 202a-g is positioned externally to the main structure of the aircraft 110. Thus, at least one-third to one-half of a height of the cylinders 202a-g are positioned externally to the aircraft 110.

In one example of the dimensions, the cylinders 202a-g are approximately 100 meters (m) in height, e.g., with approximately 50 m within the main structure of the aircraft 110 and approximately 50 m external to the aircraft 110, and have a length of approximately 84 m. In this example, each cylinder 202a-g forms 250 m of the guideway 200, with the seven cylinders 202a-g forming a total length of 1,750 m. The aircraft 110 in this example, such as shown in FIG. 1, is an airship or dirigible with an approximate length of 250 m, height of at least 50 m, and width of 50 m. The cylinders 202a-g thus fit within the limited dimensions of the airship while still forming a lengthy guideway 200 of 1,750 m. This configuration of the guideway 200 thus provides an improvement in length within a confined area over other geometric shapes and configurations previously known for rail guns and launchers. The lengthy guideway 200 further allows for a controlled and gradual increase of speed for a vessel through the guideway while maintaining the structural integrity of the launch system 100.

The launch system 100 may include electromagnetics and superconductivity similar to one or more of Maglev Trains, Particle Accelerators and components of Railguns and Coil Guns. For example, the launch system 100 may include accelerator components up to a bore area or pathway for the vessel. These accelerator components include one or more of: superconducting magnets, such as electromagnetic coils of superconducting material (e.g., niobium-titanium alloy, aluminum, tin, lead), compensation coils, cryogenic cooling system (e.g., including liquid helium and/or nitrogen), electromagnetic propulsion system, or other components.

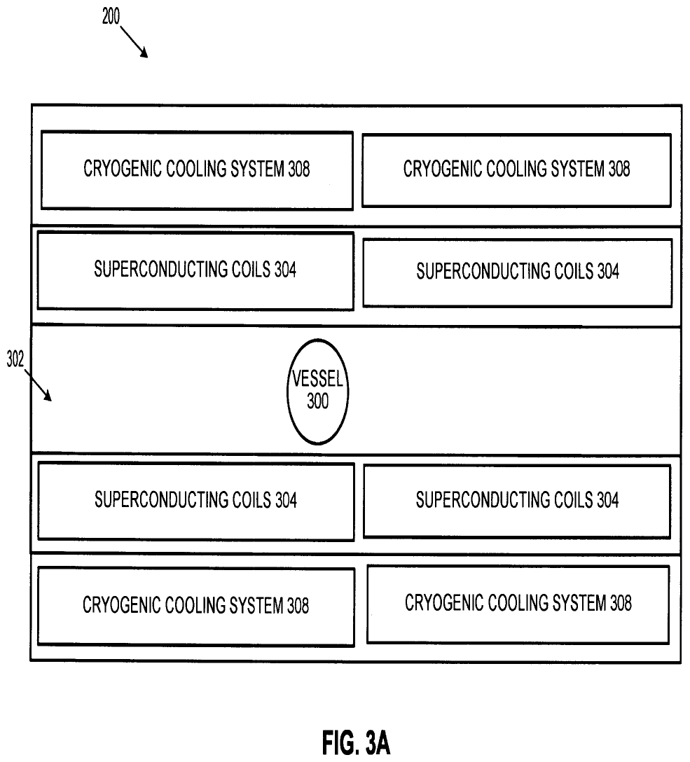

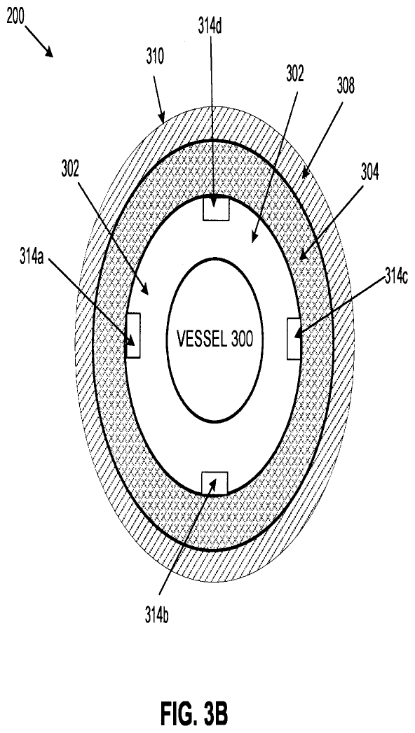

FIG. 3A illustrates a block diagram of an exemplary embodiment of a side cross-sectional view of the guideway 200. The guideway 200 includes an interior bore 302 that forms a continuous passageway for the vessel 300 through the plurality of cylinders 202a-g and bridges 224a-f. The vessel 300 may have an approximate 5 m diameter or length and have a spherical or oval shape or other shape and size configured to travel through the guideway 200. In one embodiment, a plurality of superconducting coils 304 are wrapped circumferentially around the bore 302 or otherwise positioned externally to the bore 302, wherein the coils 304 are configured to generate sufficient magnetic fields necessary for levitating the vessel 300. Superconductivity is a state in which certain materials exhibit zero electrical resistance and expel magnetic fields entirely. This unique property allows for the creation of powerful magnetic fields for levitating and/or accelerating the vessel 300 within the guideway 200. By controlling the strength and direction of these magnetic fields, the vessel 300 is levitated within the bore 302, e.g., such that the vessel 300 has little to no contact with surrounding walls or components.

The superconducting coils 304 comprise superconducting materials, such as niobium-tin and yttrium-barium-copper oxide, which exhibit superconducting properties at low temperatures, necessitating the use of cryogenic cooling system 308 to maintain the required conditions. The cooling system 308, e.g., including liquid helium and/or nitrogen, cools or reduces the temperature of the superconducting coils 304 to and/or below a transition temperature at which the superconducting material(s) in the coils 304 transition to a superconducting state. Additionally, the guideway 200 and/or bore 302 may be depressurized to a lower pressure than within the aircraft 110 or the surrounding atmosphere. This vacuum lowers the air resistance and friction on the vessel 300 as it moves through the bore 302.

The launch system 100 controls a magnetic field, e.g., using flux pinning structures or other mechanisms, as the superconducting material in the coils 304 are cooled to the transition temperature. Superconductors have a flux-trapping property such that a magnetic flux will be trapped in the superconductor if it is present when the material crosses the transition temperature threshold between conducting and superconducting states. Moreover, once the superconductor material becomes superconducting, the superconductor will reject any further imposition of magnetic flux. This property is referred to as flux-exclusion. The aforementioned properties enable superconductors to function as powerful artificial magnets and facilitate efficient levitation and/or acceleration in the guideway 200. In one implementation, the superconducting material of the coils 304 has a trapped magnetic field sufficient to levitate the vessel 300 within the bore 302. In other implementations, the magnetic field control system does not generate a magnetic flux, and the superconducting coils 304 are transitioned to a superconducting state without a trapped magnetic field.

In operation, the superconducting coils 304 generate a magnetic field around or in the walls of the bore 302. This magnetic field repels a surface and/or outer shell of the vessel 300 that has a polarization that is opposite to the magnetic field. The vessel 300 is then repelled by the magnetic field around the walls and remains levitated within the bore 302 without little to no contact with the walls. In one example, the vessel 300 may include superconducting material, e.g. in an outer shell, or outer layer near the surface, or an inner layer or body. The surface of the vessel 300 is partially or substantially coated with cryogenic liquid such that the vessel 300 is repelled by the magnetic field of the superconducting coils 304. Additionally or alternatively, electromagnetic (and possibly superconducting) coils in the vessel 300 may generate a magnetic field in or around a surface of the vessel 300 in response to a current, e.g., from a battery in the vessel 300, traveling through the electromagnetic coils. The magnetic field generated by the vessel 300 interacts with and is repelled by the magnetic field of the superconducting coils 304.

FIG. 3B illustrates a block diagram of an embodiment of a middle cross-section of the guideway 200. The guideway 200 includes an outer, cylindrical casing 310 that may be comprised of a strong, non-conducting material, such as concrete, plastics, carbon, carbon fiber, ceramic (material), fiberglass, or other non-magnetic materials. In one example, the bore 302 of the guideway 200 is approximately 6 meters (m) and the outer casing 310 is approximately 2 inches thickness. The radial distance between the outer casing 310 to the bore 302 is approximately 3 m and contains the electromagnetic coils 304, cooling system 308 and other components, such as flux pinning structures (not shown) or compensation coils (not shown).

In one embodiment, the guideway 200 includes a propulsion system having, e.g., one or more propulsion coils 314a-d (such as electromagnetic, superconducting coils 304) for controlling the velocity of the vessel 300. In one example, the propulsion coils 314a-d are separate from the superconducting coils 304 such that the superconducting coils 304 provide levitation of the vessel 300 within the bore 302 while the propulsion coils 314a-d control a speed of the vessel 300. In another example, the superconducting coils 304 include the propulsion coils 314a-d.

One or more strategically placed propulsion coils 314a-d on the guideway are used to exert an additional acceleration force on the vessel 300. For example, the propulsion coils 314a-d may be placed at a predetermined position within the guideway 200, such as a bottom portion or loop of a cylinder 202a. The propulsion coils 314a-d exert a booster force on the vessel 300 through a higher-powered electrical current in the propulsion coils 314a-d generating a stronger magnetic field to accelerate the vessel 300. The frequency and power of the current is synchronized to match with the return loop trip of the vessel 300 through the predetermined position of the propulsion coils 314a-d. The interaction between the superconducting material on a surface, or in an outer layer or shell near the surface, of the vessel 300 and the applied booster pathway field creates an acceleration force moving the vessel 300 forward. The launch system 100 may then control the power or current to the propulsion coils 314a-d to increase and/or decrease the magnetic field generated by the propulsion coils 314a-d and so increase or decrease a velocity of the vessel 300. In an embodiment, the propulsion coils 314a-d may comprise superconducting material and be cooled to superconductivity by the cooling system 308.

In operation, the launch system 100 determines a position of the vessel 300 within the guideway 200 and activates one or more of the propulsion coils 314a-d as the vessel 300 approaches and/or moves away from the activated one or more propulsion coils 314a-d. When the bore 302 is depressurized, little to no air resistance may exist to slow the vessel 300 as it travels through the guideway 200 such that the vessel 300 maintains its approximate speed induced by the propulsion coils 314a-d. When air resistance is present, additional propulsion coils 314a-d may be positioned in the guideway 200 to maintain and/or increase the speed of the vessel 300 through the guideway 200.

The implementation of the superconducting magnets and guideway 200 in FIGS. 3A and 3B are exemplary. Further details and/or alternative embodiments are described in the article: Toral, Fernando. “Mechanical design of superconducting accelerator magnets.” arXiv preprint arXiv:1501.02932 (2015), the entirety of which is hereby incorporated by reference herein.

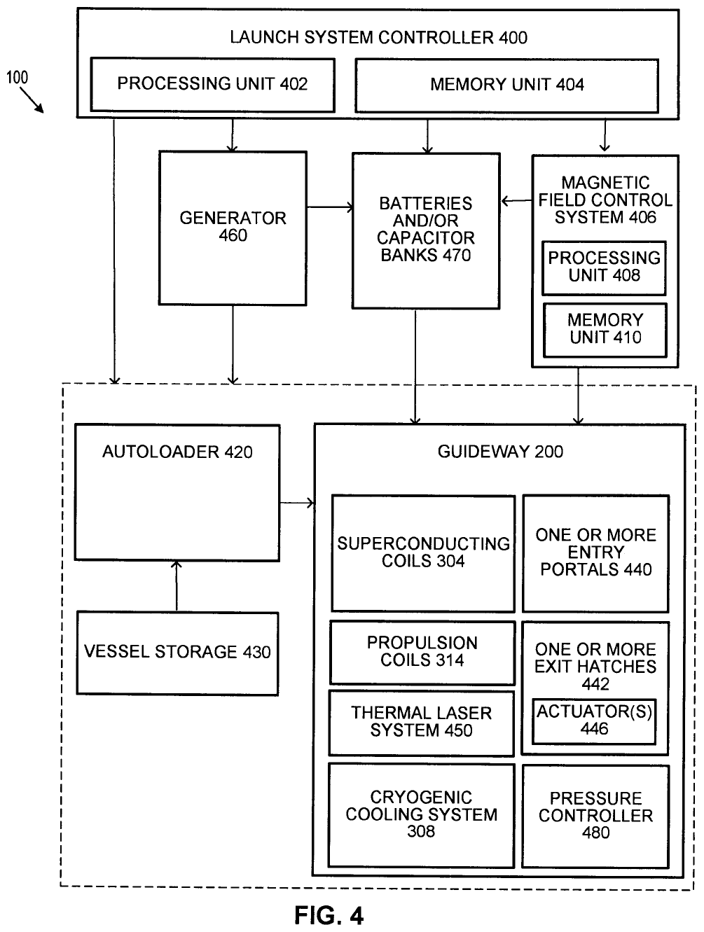

FIG. 4 illustrates a block diagram of an embodiment of the launch system 100. The launch system 100 includes at least one launch system controller 400 having at least one processing unit 402 and at least one memory unit 404. The processing unit 402 includes at least one processor, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The memory unit 404 includes at least one non-transitory memory device that is internal or external to the processing unit 402. The memory unit 404 may include a single memory device or a plurality of memory devices. The at least one memory device may be a read-only memory, random access memory, volatile memory, non-volatile memory, static memory, dynamic memory, flash memory, cache memory, and/or any non-transitory memory device that stores digital information and is readable by the processing unit 402.

The memory unit 404 stores computer-executable instructions which when executed by the processing unit 402, causes the launch system 100 to perform one or more functions described herein. The computer-executable instructions may include, e.g., program modules such as routines, programs, objects, components, data structures, etc. that perform particular tasks or implement particular abstract data types. Such instructions may be implemented in a high-level procedural or object-oriented programming language to communicate with a computer system. However, the program(s) can be implemented in assembly or machine language, if desired. In any case, the language may be a compiled or interpreted language, and combined with hardware implementations.

The launch system 100 may include a separate magnetic field control system 406 to operate the superconducting coils 304, propulsion coils 314, pressure controller 480, or other additional or alternative components. In another implementation, the launch system controller 400 may perform one or more operations described herein with respect to the magnetic field control system 406. The magnetic field control system 406 may also include a processing unit 408 and memory unit 410. The memory unit 410 stores computer-executable instructions which when executed by the processing unit 408, causes the guideway 200 and/or other components to perform one or more functions described herein.

The launch system 100 may further include one or more capacitor banks and/or batteries 470 or other power source for powering the guideway 200, and in specific the superconducting coils 304 and the one or more propulsion coils 314. A generator 460 may charge or power the capacitor bank and/or batteries 470, e.g., using hydrogen or other fuel. A vessel storage 430 is configured to store one or more vessels 300, as described in more detail herein. An autoloader 420 retrieves one or more vessels 300 from the vessel storage 430 and loads the one or more vessels into the guideway 200. The propulsion system may comprise the superconducting coils 304 and/or the separate propulsion coils 314 and/or other mechanisms to accelerate the vessel 300 within the guideway 200.

In one embodiment, the guideway 200 may include one or more entry portals 440 and one or more exit hatches 442. The autoloader 420 may load one vessel 300 or a plurality of vessels into one or more entry portals 440. For multiple vessels 300, the magnetic field control system 406 may maintain a same speed for the plurality of vessels 300 in the guideway. The plurality of vessels 300 will thus travel through the guideway 200 without collision. The plurality of vessels 300 may then be launched from the guideway 200 through one or more exit hatches 442. Actuators 446 at the one or more exit hatches 442 are adjusted to a launch angle in response to the predetermined flight trajectory or pathway of the vessel 300. In one example, the actuators 446 may adjust a launch angle of the vessel 300 from 75 degrees to 105 degrees.

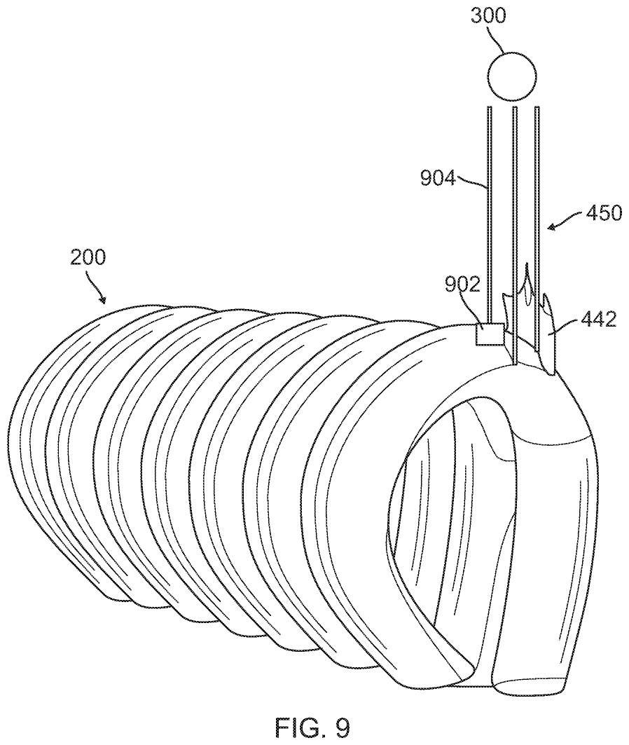

The guideway 200, as discussed herein, may have a lower pressure than the other parts of the aircraft 110. The pressure controller 480 operates to lower the pressure in the guideway 200, such as in the bore 302, to either match with the air pressure in the surrounding stratosphere (e.g., between 2.9 pounds per square inch (psi) and 0.014 psi). In other embodiments, the pressure controller 480 may lower the air pressure further to the lower air resistance on the vessel 300. The pressure controller 480 may also operate to pressurize the aircraft 110 as it ascends. In general, a pressurization of 11 pounds per square inch (psi) is maintained for a manned aircraft. The launch system 100 may further include a thermal laser system 450 that generates one or more laser beams into a flight trajectory or pathway of the vessel 300 after launch, as explained in more detail with respect to FIG. 9.

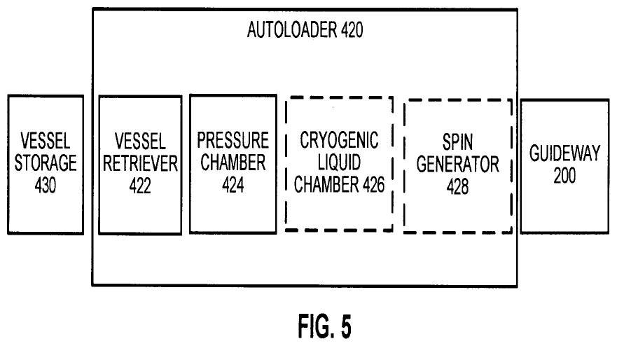

FIG. 5 illustrates a schematic block diagram of an embodiment of the autoloader 420. The autoloader 420 includes a vessel retriever 422 that obtains a vessel 300 from the vessel storage 430. The vessel retriever 422 may include an arm or boom that swivels about a main post or other structure to a vicinity at or near a vessel 300 in the vessel storage 430. A robot, robot arm, conveyor belt, or other mechanisms may then place the vessel 300 into or on or otherwise attach the vessel 300 to the arm or boom of the vessel retriever 422.

The autoloader 420 may further include a pressure chamber 424 configured to adjust between a pressure of the vessel storage 430 and the pressure in the guideway 200. For example, in the stratosphere, the bore 302 of the guideway 200 may be at 0.014 psi (pressure in the stratosphere) and the vessel storage 430 may be pressured to 11 psi (average pressurization of manned aircraft). The vessel 300 enters the pressure chamber 424 at a pressure of the vessel storage 430 and the pressure controller 480 lowers the pressure in the chamber to approximately the pressure of the bore 302 (within a tolerance of +/−10% of the pressure in the bore).

The autoloader 420 may further include a chamber 426 with a cryogenic liquid. If the vessel 300 does not include magnetized components, or to strengthen the magnetism of the vessel 300, the vessel 300 is coated in a cryogenic liquid that forms a layer over a surface of the vessel 300. For example, the cryogenic liquid may comprise cryogenic liquid nitrogen. Though liquid nitrogen is not magnetic in normal conditions, nitrogen molecules are repelled by a magnetic field. The surface of the vessel 300 will thus be at least partially or substantially coated with the cryogenic, liquid nitrogen in the guideway 200. As such, the magnetic field of the superconducting coils 304 will repel the nitrogen molecules and levitate the coated vessel 300 within the bore 302. Additionally or alternatively, electromagnetic, superconducting coils are cooled by the cryogenic liquid and may generate a magnetic field in or around a surface of the vessel 300, e.g., in response to a current from a battery in the vessel 300. The magnetic field generated by the vessel 300 interacts with and is repelled by the magnetic field of the superconducting coils 304 in the guideway 200. Additionally or alternatively, the surface of the vessel 300 may include a ferromagnetic material that repels the magnetic fields of the superconducting coils 304 in the guideway 200. Such a ferromagnetic shelled vessel 300 is not coated with the cryogenic liquid.

The autoloader 420 may further include a spin generator 428 that spins the vessel 300 prior to entering the guideway 200. For example, the vessel 300 may include a spherical or bullet or football type structure that may obtain lift or other benefits from spinning during flight. The spin generator 428 initiates spin of the vessel 300. Within the guideway 200, the superconducting coils 304 and/or propulsion coils 314 and/or other mechanism may maintain or increase the rotational spin of the vessel 300.

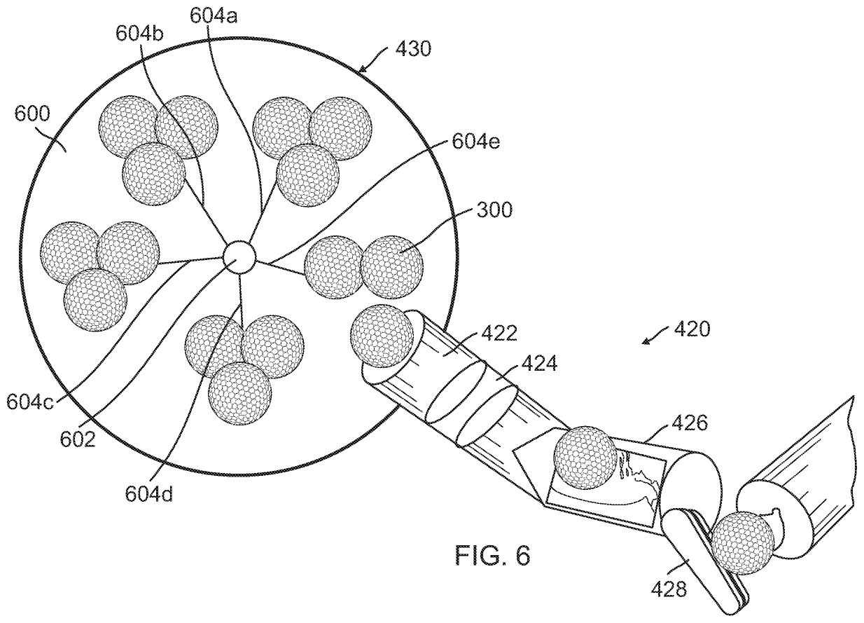

FIG. 6 illustrates an elevational view of an embodiment of the vessel storage 430 and autoloader 420. In this example, the vessel storage 430 includes a storage structure 600 with a hub 602 and one or more spokes 604a-e that extend outward from and rotate about the hub 602. The spokes 604a-e each have one end attached to the hub 602 and another end attached to a preconfigured number of vessels 300. The preconfigured number corresponds to the number of vessels 300 that are loaded and circulate within the guideway 200 at a same time. In this example, the spokes 604a-e attach three vessels though fewer or more vessels 300 may also be implemented.

In operation, the hub 602 rotates a spoke 604e for loading of a first vessel 300 by the vessel retriever 422 into the autoloader 420. The first vessel 300 is transported through the pressure chamber 424 and cryogenic liquid chamber 426. A spin generator 428, such as a flipper accelerator or other lever, initiates spin of the first vessel 300 and/or propels the vessel into an entry portal 440 into the guideway 200.

The autoloader 420 may then load a second vessel 300 from the same spoke 604e into the same first entry portal 440, or into a second entry portal into the guideway 200. Similarly, the autoloader 420 may then load a third vessel 300 from the same spoke 604e into the same first entry portal 440 or into a third entry portal into the guideway 200. For example, the first entry portal 440 may be located on a first end cylinder 202a of the plurality of cylinders 202a-g, the second entry portal 440 may be located on the fourth or middle cylinder 202d, and the third entry portal 440 may be located on a second end cylinder 202g. In another embodiment, multiple autoloaders 420 may be implemented to load the vessels 300 into one or more of the entry portals 440.

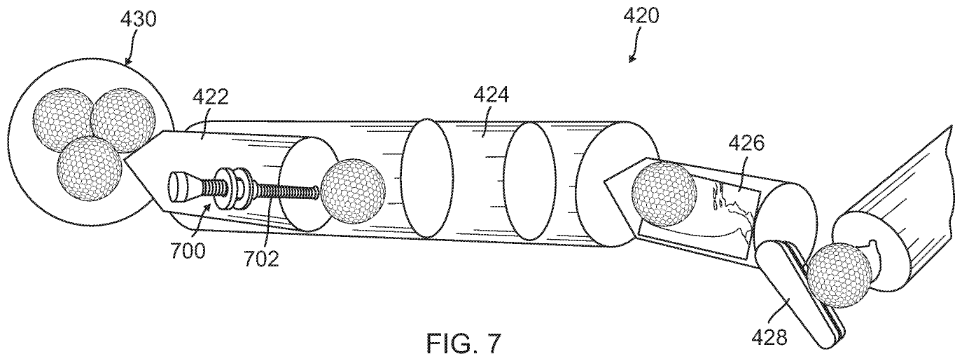

FIG. 7 illustrates an elevational view of another embodiment of the vessel storage 430 and autoloader 420. The vessel retriever 422 in this embodiment includes a cylindrical boom 700 with a spring 702 to push the vessel 300 into the autoloader 420.

In FIG. 6 and FIG. 7, the vessel 300 is shown in one embodiment as a sphere with a plurality of dimples. This embodiment of the vessel 300 is described in more detail in U.S. patent application Ser. No. ______, entitled, “SYSTEM AND METHOD FOR DIMPLED SPHERICAL STORAGE UNITS,” by inventor Thomas Yost, and filed on the same day as this application, the entirety of which is incorporated by reference herein. In other embodiments, the vessel 300 may include a sphere without dimples or a substantially spherical structure, or be formed in an oval-type shape or bullet-type shape. The vessel 300 may have an approximate 5 m diameter or length or other shape or size configured to travel through the guideway 200.

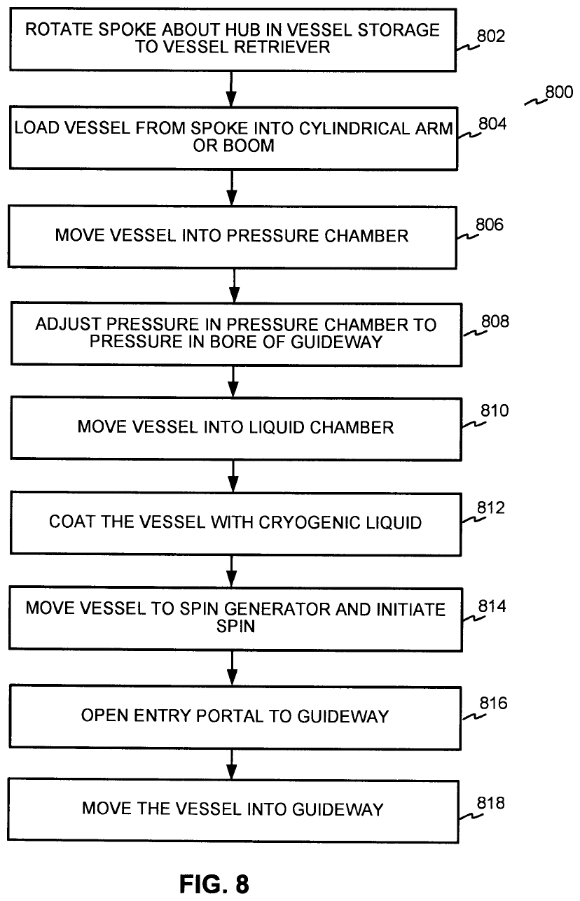

FIG. 8 illustrates a flow diagram of an embodiment of a method 800 for loading a vessel 300 into the guideway 200. At 802, a selected spoke 604a-e is rotated about the hub 602 in the vessel storage 430 to a vicinity at or near the vessel retriever 422. At 804, a selected vessel from the selected spoke 604a-e is loaded into a cylindrical arm or boom of the autoloader 420. At 806, the vessel is moved into a pressure chamber 424. At 808, the pressure in the pressure chamber is adjusted to approximately a pressure of the bore 302 in the guideway 200. At 810, the vessel 300 is moved into a cryogenic liquid chamber 426. At 812, the vessel 300 is coated, at least partially or substantially, with a cryogenic liquid, such as cryogenic, liquid nitrogen. At 814, the vessel is moved to a spin generator 428 that initiates the vessel 300 to spin. At 816, the entry portal to the guideway is opened, and at 818, the vessel 300 is moved into the guideway 200.

One or more of these steps described with respect to FIG. 8 may not be performed. For example, the vessel 300 may not be moved to the pressure chamber and/or the pressure not adjusted in the pressure chamber when the vessel storage 430 is at an approximately same pressure as the bore 302 of the guideway 200. In addition, the vessel 300 may not be moved to a liquid chamber or coated with a magnetic liquid when the vessel 300 includes magnetic components, such as magnets or electromagnetic coils. Further, the vessel 300 may not be moved to a spin generator when no spin is configured for the vessel 300.

FIG. 9 illustrates an elevational view of an embodiment of a thermal laser system 450. The thermal laser system 450 includes one or more lasers 902 that generate laser beams 904 into a flight trajectory of the vessel 300. The launch system controller 400 determines a flight trajectory or path for a vessel 300 after launch from the guideway 200. The thermal laser system 450 generates one or more laser beams 904 into the atmosphere that at least partially or substantially intersect the determined flight trajectory of the vessel 300. In this example, three laser beams 904 are shown in FIG. 9.

The one or more laser beams 904 create a tube or pathway of warm air within the cold temperatures of the stratosphere. This warm air assists the speed and direction (e.g., maintaining a desired launch angle) of the vessel 300. Also, the warm air helps the vessel 300 transition from the vacuum of the bore 302 into the more pressurized atmosphere of the stratosphere.

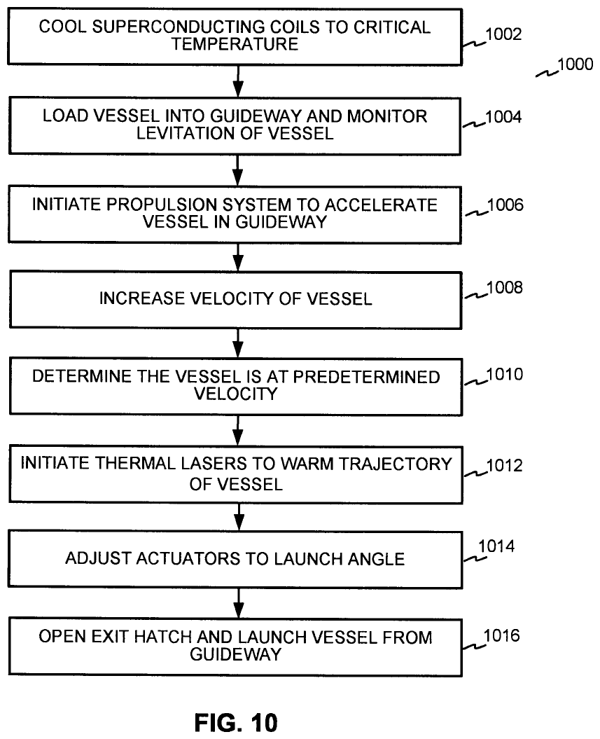

FIG. 10 illustrates a flow diagram of an embodiment of a method 1000 for launching a vessel 300 from the guideway 200. The aircraft 110 ascends to a predetermined altitude in the stratosphere, e.g., an altitude between 12 km and 50 km, and stabilizes its altitude and tilt. At 1002, the superconducting coils 304 are cooled to a transition temperature for superconductivity. At 1004, the vessel 300 is loaded into the guideway 200, and levitation of the vessel 300 within the bore 302 is confirmed and monitored. At 1006, the propulsion system, such as the propulsion coils 314 and/or the superconducting coils 304, accelerate the vessel in the guideway 200. At 1008, the velocity of the vessel 300 is increased until at 1010, the vessel 300 is determined to reach a predetermined velocity, e.g., such as an escape velocity necessary to reach space. The predetermined velocity may be determined using one or more factors, such as an altitude of the aircraft 110, air pressure, temperature, wind speed, trajectory of the vessel 300, or planned use of thrusters on the vessel 300.

At 1012, thermal lasers are initiated to warm a determined flight trajectory or pathway of the vessel 300. At 1014, actuators 446 at the exit hatch 442 are adjusted to a predetermined launch angle in response to the determined flight trajectory or pathway of the vessel 300. In one example, the actuators 446 may adjust a launch angle of the vessel 300 from 75 degrees to 105 degrees. At 1016, the exit hatch 442 is opened and the vessel 300 is launched from the guideway 200 at the launch angle. Due to the length of the guideway 200, the exit hatch 442 has sufficient time to open. For example, if the vessel 300 is traveling at Mach 2.5 to Mach 5 in the guideway 200, and the guideway is approximately 1,750 m, the vessel 300 travels from the far side of the guideway 200 to the exit hatch 442 in approximately one second; time enough to open the exit hatch 442.

In one embodiment, the predetermined velocity and/or flight trajectory of the vessel 300 are sufficient for the vessel 300 to reach space, e.g., to reach at least an 80 km altitude above Earth (US NOAA and Military definition of space) or to reach a 100 km altitude (international community definition of space). In another embodiment, the predetermined velocity and/or flight trajectory are insufficient for the vessel 300 to reach space. The vessel 300 may include thrusters to gain further altitude and/or adjust its trajectory.

The launch system 100 reduces the escape velocity necessary for the vessel 300 to reach space in comparison to traditional rockets or rail guns located on the ground for several reasons. First, the aircraft 110 launches the vessel 300 from the stratosphere, and the vessel 300 may further include thrusters to assist the vessel 300 in reaching space. Second, in one embodiment, the vessel 300 includes dimples and/or has spin that provide additional lift. Third, the launch angle of the vessel 300 may be adjusted for a shorter pathway or trajectory to reach its desired altitude and position. These advantages of the launch system 100 are exemplary and additional and/or alternate advantages may exist.

### Exemplary Embodiments of the Aircraft

In one embodiment, the aircraft 110 is an airship, also known as a dirigible or blimp. Airships achieve lift by displacing a volume of air with a gas that is lighter than air (such as helium), enabling them to ascend and remain airborne. Additionally, propulsion systems, often comprising propellers or engines, allow airships to maneuver and navigate through the atmosphere. The use of both buoyancy and propulsion enables airships to travel efficiently over long distances with substantial cargo capacities, making them a compelling mode of transport for stratospheric flight with the launch system 100. Currently known or traditional airships may be retrofitted or integrated with the launch system 100 described herein. Another possible embodiment of an airship that may be employed as the aircraft 110 is described in more detail in U.S. patent application Ser. No. ______, entitled “SYSTEM AND METHOD FOR A STRATOSHPERIC AIRCRAFT,” by inventor Thomas Yost, and filed on the same day as this application, the entirety of which is incorporated by reference herein.

In addition to airships, the aircraft 110 may be an airplane configured to fly to the stratosphere. Another exemplary embodiment of the aircraft 110 is a tilt-rotor aircraft, such as Bell Boeing V-22 Osprey®, which can fly like a helicopter and an airplane. In addition, some helicopters can reach altitudes in the lower stratosphere of approximately 12 km.

In other embodiments, the launch system 100 may be used on an aircraft 110 at altitudes below 12 km. In this implementation, depending on the altitude of the aircraft 110, the guideway 200 accelerates the vessel 300 to a speed necessary to reach a selected altitude, e.g., an altitude within the stratosphere or further. When launched at lower altitudes, the thrusters on the vessel 300 may also be used to reach a selected altitude or space.

In still other embodiments, the launch system 100 may be implemented on ground. The size of the individual cylinders 202 and/or the number of cylinders 202 may be increased and/or a weight or size of the vessel 300 may decrease to generate greater vessel speeds.

In still another embodiment, though a lower portion the cylinders 202a-g is described positioned within the main structure of the aircraft 110 and an upper portion of the cylinders 202a-g is described positioned externally to the main structure of the aircraft 110, the cylinders 202a-g may be positioned entirely or substantially within the main structure of the aircraft 110 and/or under a dome or other structure. In another embodiment, the cylinders 202a-g may be positioned substantially external to the aircraft 110.

In one application, the vessels 300 are launched into space to provide cargo for building a moon base: food supplies, mining equipment, reactor parts, oxygen, greenhouses, plants, concrete, soil, fertilizer, oxygen, water, drilling equipment, pipes and reactor parts and water filtration. The launch system 100 and vessel 300 may thus provide the transport into the Solar System the materials needed to build a city's water & food supplies, infrastructure, shelter, and power plants to bring light & electricity for new settlements on the Moon or even on Mars. The cargo may further include components for a launch system 100 and/or vessel 300 that can be implemented on the Moon. The launch system 100 may then launch the vessel 300 from the Moon to Earth. The vessel 300 may orbit Earth for pick-up by a spaceship or space shuttle. In another embodiment, the vessel 300 is configured to withstand re-entry into Earth's atmosphere. The vessel 300 may include cargo such as Helium-3 (an isotope needed for clean nuclear fusion).

As may be used herein, the term “operable to” or “configurable to” indicates that an element includes one or more of components, dimensions, circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled,” “coupled to,” “connected to” and/or “connecting” or “interconnecting” includes direct connection or link between components or between nodes/devices and/or indirect connection between components or nodes/devices via an intervening item. As may further be used herein, inferred connections (i.e., where one element is connected to another element by inference) includes direct and indirect connection between two items in the same manner as “connected to.” As may be used herein, the terms “substantially” and “approximately” provides an industry-accepted tolerance for its corresponding term and/or relativity between items.

Note that the aspects of the present disclosure may be described herein as a process that is depicted as a schematic, a flow chart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

In the foregoing specification, certain representative aspects have been described with reference to specific examples. Various modifications and changes may be made, however, without departing from the scope of the present invention as set forth in the claims. The specification and figures are illustrative, rather than restrictive, and modifications are intended to be included within the scope of the claims. Accordingly, the scope of the claims should be determined by the descriptions herein and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

1. A launch system for launching a vessel, comprising:
a plurality of cylinders that form a continuous guideway, wherein each of the plurality of cylinders include at least one lobe and one overlapping portion, wherein the at least one lobe of each of the plurality of cylinders are substantially aligned;
a plurality of coils that comprise one or more superconducting materials, wherein the plurality of coils are positioned external to a bore in the continuous guideway and configured to generate a magnetic field within the bore that levitates and propels the vessel within the bore; and
a cooling system configured to cool the plurality of coils to or below a transition temperature at which the one or more superconducting materials in the plurality of coils transition to a superconducting state.

2. The launch system of claim 1, wherein the one or more of the plurality of coils include propulsion coils, wherein the propulsion coils are configured to generate an increase in the magnetic field at a predetermined position in the bore to accelerate the vessel.

3. The launch system of claim 2, further comprising:
a power source configured to provide power to the propulsion coils, wherein an increase in the power to the propulsion coils increases the magnetic field at the predetermined position in the bore to increase a velocity of the vessel.

4. The launch system of claim 1, wherein each pair of adjacent cylinders of the plurality of cylinders are coupled by at least one cylinder pathway bridge, wherein the at least one cylinder pathway bridge between the each pair of adjacent cylinders forms a portion of the continuous guideway.

5. The launch system of claim 1, further comprising:
a pressure controller configured to decrease a pressure within the bore.

6. The launch system of claim 1, further comprising:
at least one exit hatch for launching the vessel from the continuous guideway; and
one or more lasers for generating one or more laser beams into a flight trajectory of the vessel.

7. The launch system of claim 1, further comprising:
at least one entry portal into the bore of the continuous guideway; and
an autoloader for loading the vessel into the continuous guideway.

8. The launch system of claim 7, wherein the autoloader comprises:
a pressure chamber configured to receive the vessel and adjust a pressure within the pressure chamber to approximately a pressure in the bore of the continuous guideway.

9. The launch system of claim 7, wherein the autoloader comprises:
a chamber configured to coat a surface of the vessel with cryogenic liquid, wherein the surface of the vessel comprises one or more superconducting materials such that a superconductivity of the surface of the vessel repels the magnetic field within the bore.

10. The launch system of claim 7, wherein the autoloader comprises:
a spin generator that initiates the vessel to spin and propel prior to entering the at least one entry portal, wherein the spin generator includes a flipper accelerator.

11. The launch system of claim 1, wherein the launch system is positioned on an aircraft.

12. The launch system of claim 11, wherein the aircraft is configured to operate in a stratosphere of Earth.

13. The launch system of claim 11, wherein a portion of the plurality of cylinders is external to the aircraft, wherein the portion includes at least one-third to one-half of a height of the plurality of cylinders.

14. The launch system of claim 1, wherein each of the plurality of cylinders comprises:
the at least one lobe;
a second lobe; and
at least one overlapping portion that connects the at least one lobe and the second lobe.

15. A launch system for launching a vessel, wherein the launch system is implemented on an aircraft, comprising:
a plurality of coils that comprise one or more superconducting materials, wherein the plurality of coils are positioned external to a bore in a guideway and configured to generate a magnetic field within the bore that levitates and accelerates the vessel within the bore;
a cooling system configured to cool the plurality of coils to at least a transition temperature at which the one or more superconducting materials in the plurality of coils transition to a superconducting state; and
a launch system controller configured to initiate a launch of the vessel from the guideway in response to the vessel reaching at least a predetermined speed within the guideway, wherein the predetermined speed is sufficient for the vessel to reach space from an altitude of the aircraft.

16. The launch system of claim 15, further comprising:
a plurality of twisted cylinders that form the guideway, wherein each of the plurality of cylinders have an infinity-type shape including a first lobe, a second lobe and an overlapping portion, wherein at least the first lobe of each of the plurality of cylinders are substantially aligned.

17. A method for launching a vessel from a launch system positioned on an aircraft, comprising:
determine the aircraft is at a stratospheric altitude;
generate a magnetic field within a guideway of the launch system, wherein the magnetic field repels the vessel and causes the vessel to levitate within a bore of the guideway;
accelerate the vessel within the bore of the guideway;
determine the vessel has reached a predetermined velocity, wherein the predetermined velocity is sufficient for the vessel to reach space from the stratospheric altitude of the aircraft; and
launch the vessel from the guideway.

18. The method of claim 17, wherein generating the magnetic field within the guideway of the launch system, comprises:
cooling a plurality of coils to or below a transition temperature at which one or more superconducting materials in the plurality of coils transition to a superconducting state and wherein the plurality of coils are positioned external to the bore in the guideway and configured to generate the magnetic field within the bore that causes the vessel to levitate and be propelled within the bore.

19. The method of claim 18, wherein accelerating the levitating vessel within the bore of the guideway, comprises:
increasing current to the plurality of coils at a predetermined position in the bore to increase the magnetic field and increase a velocity of the vessel, wherein the magnetic field interacts and repels a surface of the vessel, wherein the surface of the vessel includes superconducting material with at least a partial coverage of cryogenic liquid nitrogen or a ferromagnetic material.

20. The launch system of claim 17, wherein launching the vessel from the guideway, comprises:
adjusting one or more actuators at an exit hatch to a predetermined launch angle; and
launching the vessel from the exit hatch at the predetermined launch angle.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
